(19) United States
(12) Patent Application Publication
(10) Pub. No.: US 2015/0058405 A1
(43) Pub. Date: Feb. 26, 2015

(54) METHOD FOR PROCESSING HTTP MESSAGE AND ELECTRONIC DEVICE IMPLEMENTING THE SAME

(71) Applicant: Samsung Electronics Co., Ltd., Suwon-si (KR)

(72) Inventors: Juha PARK, Suwon-si (KR); Myeongjin OH, Seoul (KR)

(21) Appl. No.: 14/467,626

(22) Filed: Aug. 25, 2014

(30) Foreign Application Priority Data
Aug. 26, 2013 (KR) 10-2013-0101010

(51) Int. Cl. H04L 29/08; H04L 29/06

(52) U.S. Cl. CPC H04L 67/02; H04L 67/42; H04L 67/16
USPC 709/203

(57) ABSTRACT

A method for processing a Hyper Text Transfer Protocol (HTTP) message in an electronic device is provided. The method includes recognizing a user's HTTP request input, generating a first HTTP request message in response to the HTTP request input, verifying the first HTTP request message, transmitting the first HTTP request message when a pass of the first HTTP request message is determined as the result of the verification, and transmitting a second HTTP request message derived from the first HTTP request message without verifying the second HTTP request message.

### CROSS-REFERENCE TO RELATED APPLICATION(S)

This application claims the benefit under 35 U.S.C. §119(a) of a Korean patent application filed on Aug. 26, 2013 in the Korean Intellectual Property Office and assigned Serial number 10-2013-0101010, the entire disclosure of which is hereby incorporated by reference.

### TECHNICAL FIELD

The present disclosure relates to a method for processing a Hyper Text Transfer Protocol (HTTP) message, for example, an HTTP request message, in an electronic device.

### BACKGROUND

The Internet is an open type computer communication network in which enterprises, institutes, libraries, schools, and individuals throughout the world search or exchange information with each other using computers. With the development of computer communication technology and the increased spread of computers, the use of the Internet has spread rapidly. However, as use of the Internet spreads and the number of Internet users rapidly increases, various kinds of harmful information that are provided from servers to clients through the Internet may cause severe side effects in society. Accordingly, research has been conducted and various methods have been proposed to block such harmful information.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below.

In order to access a site on a web, a user uses a web browser (e.g., INTERNET EXPLORER or CHROME). The browser internally uses a protocol named Hyper Text Transfer Protocol (HTTP). HTTP is a request/response protocol that is performed between a client and a server. For example, when the browser of the client requests a web page or picture information from the server via HTTP, the server transfers necessary information to the browser of the client in response to the request. This information is provided to a user through an output interface unit, such as a monitor. An HTTP request message includes address information of a site to be accessed, that is, a Uniform Resource Locator (URL). Based on such address information, it is determined whether to block the corresponding site (e.g., whether to transmit the HTTP request message to the server).

In order to limit a user's access to a specific site, a process is required to monitor the existence/nonexistence of the HTTP request message in data (e.g., an outbound packet), to hook the corresponding data when the HTTP request message exists, and to determine whether to transmit the HTTP request message of the hooked data. Since this process consumes a large amount of resources on the system, performance issues may exist.

In accordance with an aspect of the present disclosure, a procedure to determine whether information that a user intends to access is harmful is minimized, and thus the performance of a corresponding electronic device is optimized. Further, according to various aspects of the present disclosure, a method for appropriately blocking harmful information from the user and an electronic device implementing the method are provided.

In accordance with an aspect of the present disclosure, a method for processing an HTTP message is provided. The method includes recognizing a user's HTTP request input, generating a first HTTP request message in response to the HTTP request input, verifying the first HTTP request message, transmitting the first HTTP request message when a pass of the first HTTP request message is determined as the result of the verification, and transmitting an HTTP request message derived from the first HTTP request message without verifying the derived HTTP request message.

In accordance with another aspect of the present disclosure, an electronic device is provided. The electronic device includes an input interface unit configured to generate a user's HTTP request input, a memory configured to store a programming module configured to perform recognizing the HTTP request input, generating a first HTTP request message in response to the HTTP request input, verifying the first HTTP request message, transmitting the first HTTP request message when a pass of the first HTTP request message is determined as the result of the verification, and transmitting an HTTP request message derived from the first HTTP request message without verifying the derived HTTP request message, at least one processor configured to execute the programming module, and a communication unit configured to perform data communication with an external server under the control of the at least one processor.

In accordance with an aspect of the present disclosure, the procedure to determine whether information that the user intends to access is harmful is minimized, and thus the performance of the corresponding electronic device is optimized. Further, according to the various embodiments of the present disclosure, the method for appropriately blocking harmful information from the user and the electronic device implementing the method is provided.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating the configuration of a programming module according to an embodiment of the present disclosure;

FIG. 2 is a block diagram illustrating the configuration of an electronic device according to an embodiment of the present disclosure;

FIG. 3 is a flowchart illustrating a method for processing a hypertext message according to an embodiment of the present disclosure;

FIG. 4 is a flowchart illustrating a method for processing a hypertext message according to another embodiment of the present disclosure; and

FIG. 5 is a flowchart illustrating a method for processing a hypertext message according to still another embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

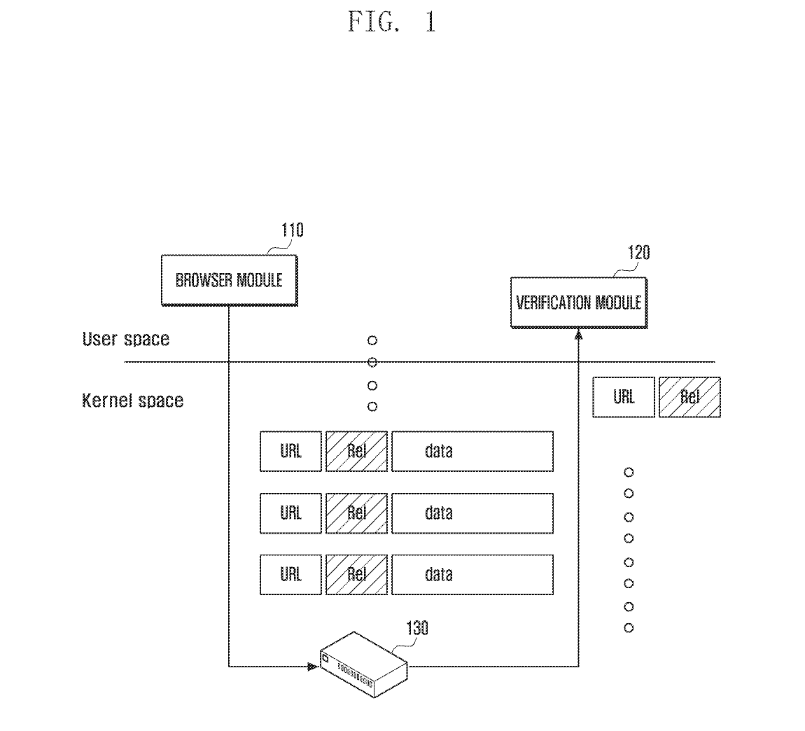

FIG. 1 is a block diagram illustrating the configuration of a programming module according to an embodiment of the present disclosure.

Referring to FIG. 1, a programming module may include a browser module 110, a verification module 120, and a filtering module 130.

The browser module 110 may generate a Hyper Text Transfer Protocol (HTTP) request message in response to a user's hypertext request to transfer the generated HTTP request message to the filtering module 130. The verification module 120 may perform verification with respect to data transferred from the filtering module 130. The browser module 110 may be an application that uses HTTP. The browser module 110 may be a process independent of the verification module 120 and the filtering module 130. The verification module 120 may perform a function of determining whether to pass a corresponding message (i.e., whether to transmit the request message to an external server) through analysis of address information (e.g., a Uniform Resource Locator (URL)) transferred from the filtering module 130.

The filtering module 130 may monitor data (e.g., an outbound packet) and hook the monitored data when the monitored data is the HTTP request message. For example, the filtering module 130 may hook the HTTP request message before a kernel sends the HTTP request message to the external server. For such hooking, the filtering module 130 may be a part of the configuration of the kernel. Further, the filtering module 130 may extract address information and a reference field from the HTTP request message and send the extracted address information and reference field to the verification module 120. In this case, the filtering module 130 may determine whether to transmit the address information to the verification module 120 with reference to the reference field that is one of fields that constitute the HTTP request message.

The operation performed by the programming module illustrated in FIG. 1 will be described.

When a user clicks a link of a web page or inputs address information, the browser module 110 may generate and transfer the HTTP request message to the kernel. The kernel may attempt to transmit the HTTP request message to the external server. In this case, the filtering module 130 of the kernel hooks the HTTP request message in the middle (i.e., before transmitting the HTTP request message to the server), and transfers the address information (e.g., the URL) and reference information (e.g., a reference field) to the verification module 120.

The verification module 120 may determine whether to pass the corresponding request message through analysis of the address information transferred from the filtering module 130. While it is determined whether to pass the request message, the filtering module 130 may delete the corresponding HTTP request message of the address information. In this case, when a timeout (e.g., Transmission Control Protocol (TCP) timeout) occurs, the kernel may reconstruct the corresponding HTTP request message and attempt to retransmit the HTTP request message. Here, a timer may count time when the HTTP request message is transmitted from the browser module 110 to the kernel. When the counted time exceeds a preset time, the kernel may attempt to retransmit the HTTP request message.

When a transmission block is determined by the verification module 120, the filtering module 130 may transmit a message for notifying of the transmission block to the browser module 110. When the verification module 120 determines to pass the HTTP request message, the corresponding HTTP request message may be normally transmitted to the external server. On the other hand, the subject to generate the HTTP request message may be the kernel. For example, the browser module 110 may request the kernel to generate the HTTP request message, and the kernel may generate the HTTP request message in response to the request.

According to an embodiment of the present disclosure, in order to improve the performance of an electronic device in which the program module is mounted, the filtering module 130 may minimize the verification procedure by using the reference field. For example, when a user requests a connection to “naver.com”, the electronic device may set whether to pass an initial HTTP request message before transmitting the initial HTTP request message to the external server. When it is set to pass the HTTP request message, the initial HTTP request message may be transmitted to the corresponding server, and HTTP request messages that are related to the initial HTTP request message may be derived. That is, the electronic device may transmit the initial HTTP request message to the external server, and in response to this, the external server may transmit a response message to the electronic device. In response to the response message, the electronic device may transmit a second HTTP request message that is related to the initial HTTP request message to the external server. That is, the derived HTTP request message may be an additional request message for acquiring, for example, image or link information existing on the main page of a site such as “naver.com”. The filtering module 130 receives the result of the determination through transmission of only address information of the request message that corresponds to the initial attempt to access “naver.com” to the verification module 120. With respect to the address information of the subsequently derived HTTP request message, the filtering module 130 does not transmit the corresponding HTTP request message to the verification module 120. The reason why the filtering module 130 does not send the address information of the derived request message to the verification module 120 is that in the case of the initial access of “naver.com”, the reference filed of the corresponding request message has no value (e.g., “null” is recorded in the reference field), while in the case of the derived access, the reference field of the corresponding request message has the value that indicates “naver.com”. That is, when it is determined whether to pass the initial HTTP request message, it is set whether to pass the derived HTTP request message. Accordingly, the verification process can be simplified, and thus the performance of the corresponding electronic device can be optimized.

According to an embodiment of the present disclosure, the electronic device may have the programming module mounted therein, and may be a computing device, such as a smart phone, camera, tablet Personal Computer (PC), notebook PC, desktop PC, media player (e.g., MP3 player), Personal Digital Assistant (PDA), terminal for game, and wearable computer (e.g., watch or glasses). Further, the electronic device according to the present disclosure may be a home appliance (e.g., refrigerator, TV, or washing machine) having the computing device as described above.

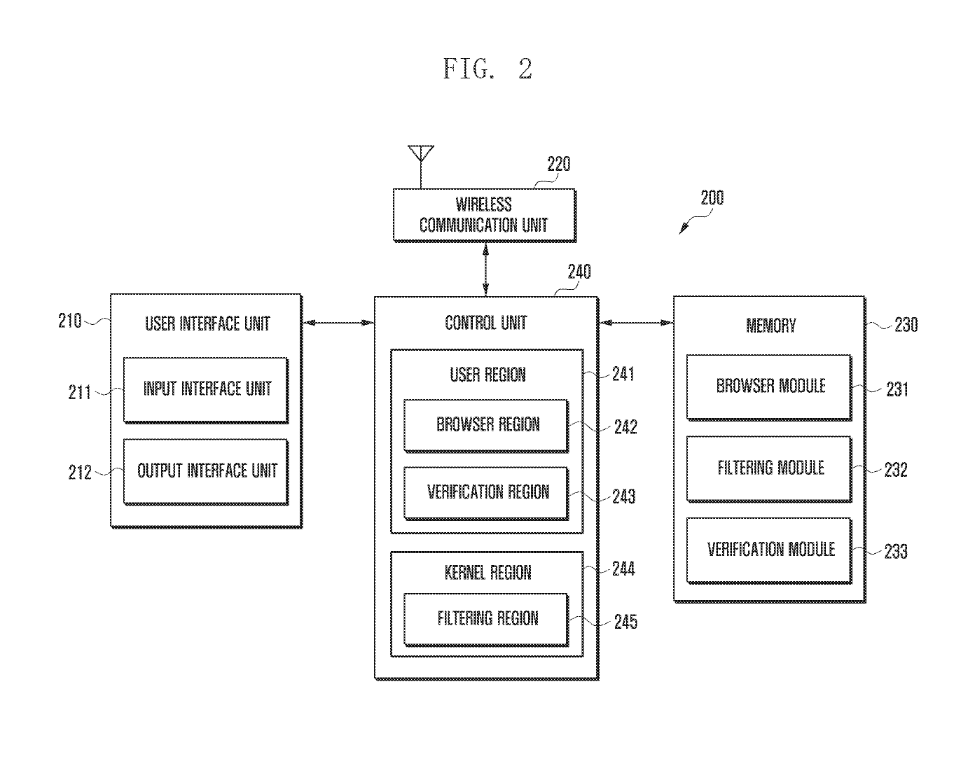

FIG. 2 is a block diagram illustrating the configuration of an electronic device according to an embodiment of the present disclosure.

Referring to FIG. 2, an electronic device 200 may include a user interface unit 210, a wireless communication unit 220, a memory 230, and a control unit 240.

The user interface unit 210 may serve as a window for interaction with a user, and may include an input interface unit 211 and an output interface unit 212 providing visual, aural, or haptic feedback to the user in response to input information received through the input interface. The input interface unit 211 may include, for example, (not shown) a touch panel, a microphone, a sensor unit, a camera, and a Global Positioning System (GPS) receiving unit. The output interface 212 may include a display unit, a speaker, and a vibration motor. The touch panel may be placed on the display unit and may generate touch data in response to a user's touch gesture input through the touch panel to transfer the touch data to the control unit 240. The touch panel may be implemented as an add-on type that is positioned on the display unit, an in-cell type, or an on-cell type that is inserted into the display unit. The touch screen includes a touch panel and a display unit. The control unit 240 may detect the touch data and may control the device 200 in response to the touch data. The microphone receives sound, such as user's voice, converts the received sound into an electrical signal, and Analog-to-Digital (AD)-converts the electrical signal into audio data to output the audio data to the control unit 240. The control unit 240 may detect voice data from the received audio data, and may control the device 200 in response to the voice data. The sensor unit detects a state change (e.g., gesture change) of the device 200 and generates and outputs sensed data related to the detected state change to the control unit 240. For example, the sensor unit may include various sensors, such as an acceleration sensor, a gyro sensor, a luminance sensor, a proximity sensor, and a pressure sensor. The control unit 240 may detect sensed data, and may control the device 200 in response to the sensed data. The camera captures an image of an object to output the captured image to the control unit 240. Specifically, the camera may include a lens gathering light, an image sensor converting the gathered light into an electrical signal, and a processor (Image Signal Processor (ISP)) converting the electrical signal input from the image sensor into image data to output the image data to the control unit 240. Here, the processor ISP may process (e.g., compresses) the image data to output the processed image data to the control unit 240. The control unit 240 may detect the image data and may control the device 200 in response to the sensed data. The GPS receiving unit receives a GPS signal from a GPS satellite, calculates the position of the electronic device 200 using the received GPS signal, and outputs the calculated position information to the control unit 240. The control unit 240 may detect the position information and may control the device 200 in response to the position information. The display unit converts the image data input from the control unit 240 into an analog signal to display the analog signal. The display unit may include a display panel, such as a Liquid Crystal Display (LCD), an Organic Light Emitting Diode (OLED), or an Active Matrix OLED (AMOLED). The speaker converts the audio data from the control unit 240 into sound to output the sound. The vibration motor provides a feedback related to haptic. For example, when the touch data is detected, the control unit 240 operates the vibration motor.

The wireless communication unit 220 may perform voice call, video call, or data communication with an external device through a network under the control of the control unit 240. For example, the wireless communication unit 220 may access the external device (e.g., a server), download content, and transfer the content to the control unit 240 under the control of the control unit 240. The control unit 240 may store the downloaded content in the memory. Further, the control unit 240 may recognize a main frame from the stored content and may control the display unit to display the main frame on a content screen. On the other hand, the wireless communication unit 220 may include a mobile communication module (e.g., a 3^{rd} Generation Partnership Project (3GPP) mobile communication module), a 3.5^{th} generation (3.5GPP) mobile communication module, a 4^{th} generation (4G) mobile communication module, a digital broadcasting module (e.g., a DMB module), a short-distance communication module (e.g., a WiFi module), a BLUETOOTH module, or a Near Field Communication (NFC) module.

The memory 230 may store data which is generated according to the operation of the electronic device 200 or is received from the external device through the wireless communication unit 220 under the control of the control unit 240. The memory 230 may include (not shown) a buffer as temporary data storage. The memory 230 may store various setting information for setting a use environment (e.g., screen brightness, existence/nonexistence of vibration when a touch occurs, and existence/nonexistence of automatic rotation of the screen). Accordingly, the control unit 240 may operate the electronic device 200 with reference to the setting information.

The memory 230 may store various programs (not shown) for operating the electronic device 200, for example, a booting program, one or more operating systems, and applications. In particular, the memory 230 may store the browser module 231, the filtering module 232, and the verification module 233. The modules 231, 232, and 233 may be programs that are set for the control unit 240 to perform various operations described below with reference to FIGS. 2 to 5. Further, the modules 231, 232, and 233 may be applications or partial configurations of the operating system, or firmware built into the processor. In particular, the browser module 231 and the verification module 233 may be independent applications or may be one application (e.g., a browser). Further, the filtering module 232 may be a partial configuration of the kernel.

The memory 230 may include (not shown) a main memory and a secondary memory. The main memory may be implemented by, for example, a Random Access Memory (RAM). The secondary memory may be implemented by a disk, a RAM, a Read Only Memory (ROM), or a flash memory. The main memory may store various kinds of programs loaded from the secondary memory, for example, a booting program, an operating system, and applications. When a battery power is supplied to the control unit 240, the booting program may be first loaded to the main memory. The booting program may load the operating program to the main memory. The operating system may load applications to the main memory. The control unit 240 (e.g., an Application Processor (AP)) may decode a command (routine) of the program through access of the main memory and may execute a function according to the result of the decoding. That is, various kinds of programs may be loaded to the main memory to operate as the processes.

The control unit 240 controls the entire operation of the electronic device 200 and a signal flow between internal configurations of the electronic device 200, processes data, and controls the power supply from the battery. The control unit 240 may include an AP. The application processor may execute various kinds of programs stored in the memory 230. That is, the application processor may operate as a process to download the various kinds of programs from the secondary memory to the main memory. In particular, the application processor may execute the modules 231, 232, and 233 as independent processes. Further, the application processor may perform simultaneous processing (i.e., multiprocessing) of the programs (e.g., the modules 231, 232, and 233).

The control unit 240 may include a user region 241 and a kernel region 244. Further, the user region 241 may include a browser region 242 and a verification region 243. Further, the kernel region 244 may include a filtering region 245. The regions 242, 243, and 245 are to execute the browser module 110, the verification module 120, and the filtering module 130 of the program module as described above with reference to FIG. 1, and may be mounted on one processor. The above-described regions 242, 243, and 245 may be physically divided in the processor. Further, the above-described regions 242, 243, and 245 may be configured as separate processors.

The control unit 240 may further include various processors in addition to the application processor. For example, the control unit 240 may include a Graphic Processing Unit (GPU) for processing graphics. Further, when the electronic device 200 is provided with a mobile communication module (e.g., 3^{rd} generation mobile communication module, 3.5^{th} generation mobile communication module, or 4^{th} generation mobile communication module), the control unit 240 may further include a Communication Processor (CP) for processing mobile communication. The above-described processors may be integrated into one package in which two or more independent cores (e.g., a quad-core) are integrated into a single integrated circuit. For example, the application processor may be integrated into one multi-core processor. The above-described processors may be integrated into one chip (e.g., a System on Chip (SoC)). Further, the above-described processors may be packaged into a multilayer.

On the other hand, the electronic device 200 may further include a configuration that has not been mentioned, such as a peripheral device interface unit (e.g., a Universal Serial Bus (USB) module), which is connected by wire to the external device to perform data communication.

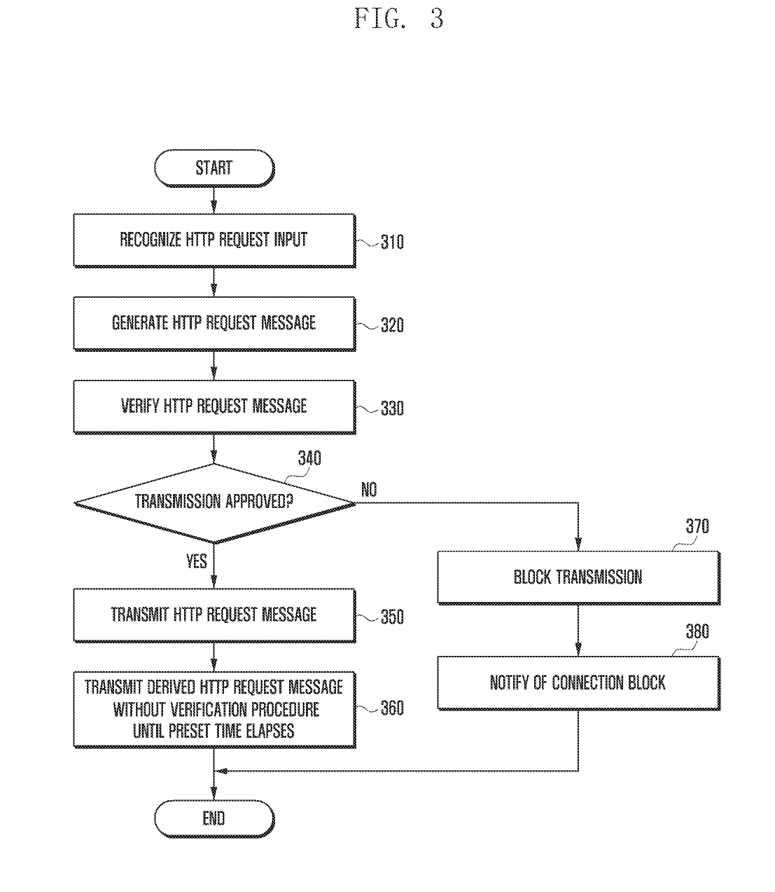

FIG. 3 is a flowchart illustrating a method for processing a hypertext message according to an embodiment of the present disclosure.

Referring to FIG. 3, at operation 310, the control unit 240 may recognize a user's hypertext request input through the user interface 210. The HTTP request input will cause an HTTP request message to be generated at operation 320. In response to the user input, at operation 330, the control unit 240 may verify the HTTP request message based on the address information of the HTTP request message. A black list of barred addresses (or a white list of permitted addresses) may exist in the memory 230. For example, the verification process may include a process of confirming whether the address information is included in such a black list (or white list). At operation 340, the control unit 240 may determine whether to approve (pass) the transmission based on the result of the verification. When it is determined that the transmission is approved (e.g., when it is verified that the address information is not present in the black list or the address information is included in the white list), the control unit 240, at operation 350, may control the wireless communication unit 220 to transmit the HTTP request message to the external server. Thereafter, at operation 360, the control unit 240 may control the wireless communication unit 220 to transmit the subsequently derived HTTP request message to the external server without verification process for a preset time (e.g., for 0.6 ms measured from the time when the HTTP request message is generated to the time when the HTTP request message is approved). That is, when the preset time elapses, the process of verifying the subsequently generated HTTP request message may be performed again. When the transmission is not approved (e.g., the address information is present in the black list or the address information is not included in the white list), the control unit 240, at operation 370, may block the transmission of the HTTP request message. Further, at operation 380, the control unit 240 may control the user interface unit 210 to notify the user that the connection of the corresponding page has been blocked. For example, the control unit 240 may control the display unit to display a block notification message.

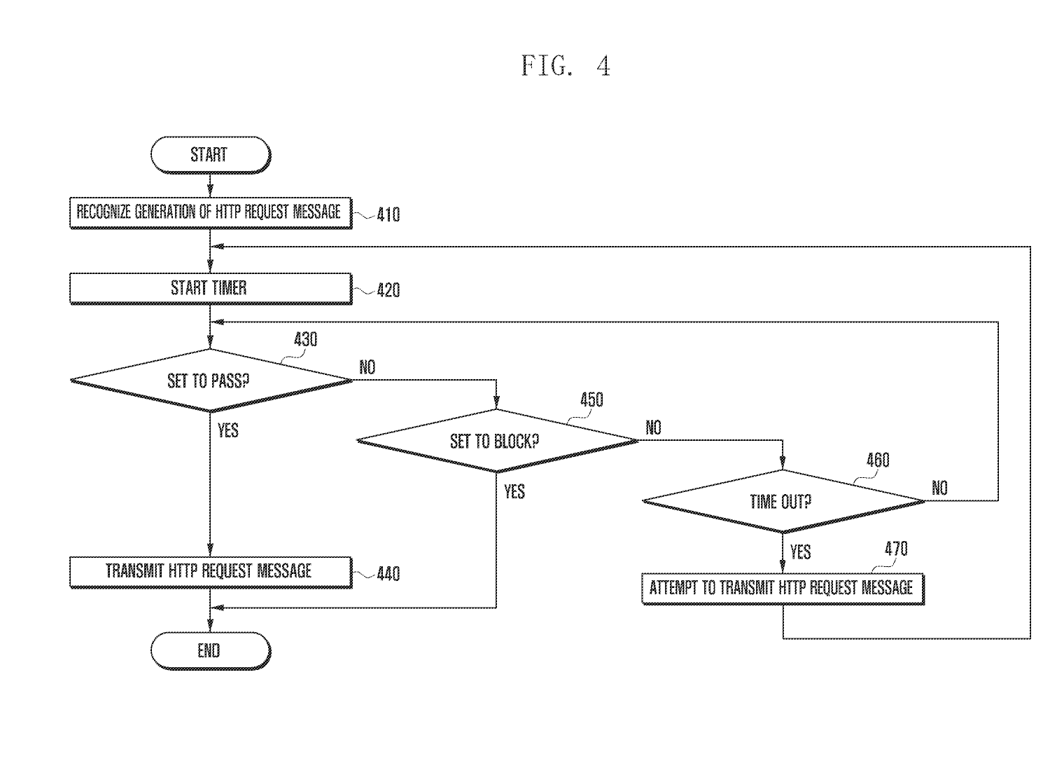

FIG. 4 is a flowchart illustrating a method for processing a hypertext message according to another embodiment of the present disclosure.

Referring to FIG. 4, at operation 410, the kernel region 244 of the control unit 240 may recognize the generation of the HTTP request message. For example, the kernel region 244 may recognize the generation of the HTTP request message through reception of the HTTP request message from the browser region 242, and thus may attempt to transmit the HTTP request message. Further, when the HTTP request message is generated, at operation 420, the kernel region 244 may operate the timer. At operation 430, the kernel region 244 may confirm whether a pass is set in the HTTP request message. When the pass is set, the kernel region 244, at operation 440, may control the wireless communication unit 220 to transmit the HTTP request message to the external server. When the pass is not set, the kernel region 244, at operation 450, may confirm whether the block is set in the HTTP request message. When the block is set, the transmission of the HTTP request message may be blocked. When the block is not set, the kernel region 244, at operation 460, may confirm whether a timeout is set. When the timeout is not set as the result of the confirmation, the process may return to operation 430. When the timeout is set as the result of the confirmation at operation 460, the kernel region 244, at operation 470, may attempt to transmit the HTTP request message again. After performing operation 470, the process may return to operation 420. On the other hand, the subject to set the block or pass may be the verification region 243.

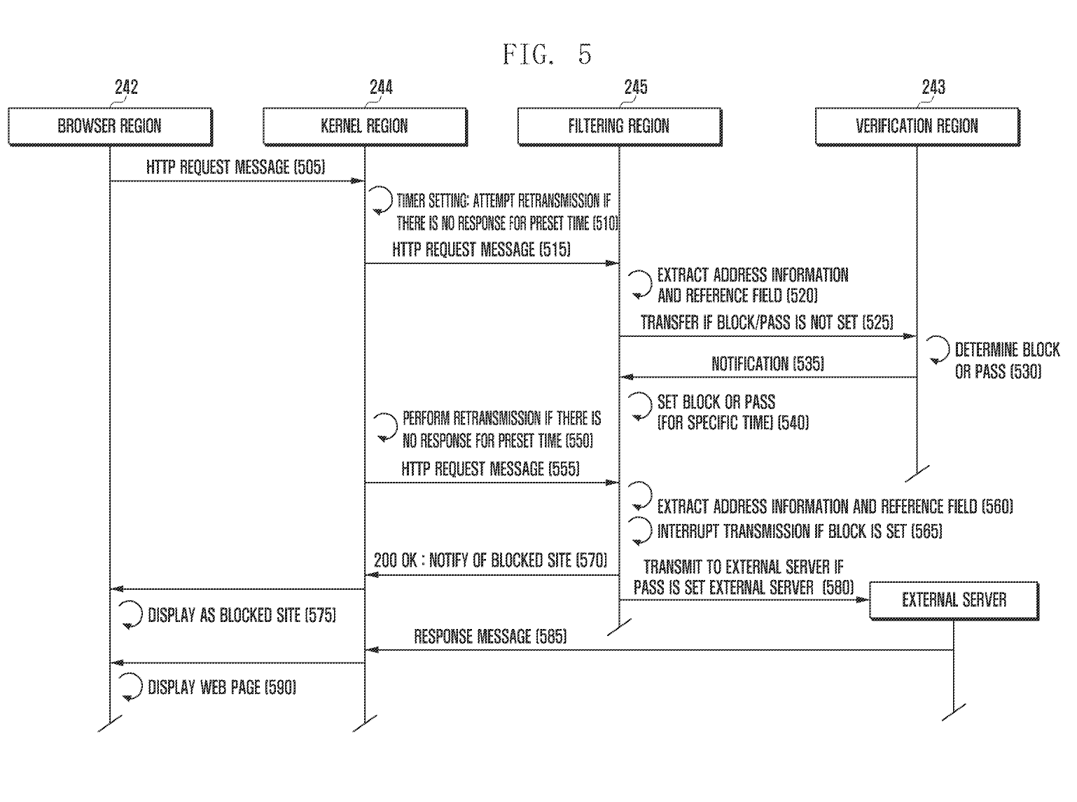

FIG. 5 is a flowchart illustrating a method for processing a hypertext message according to another embodiment of the present disclosure.

Referring to FIG. 5, at operation 505, the browser region 242 may generate the HTTP request message and may transfer the generated HTTP request message to the kernel region 244.

When the HTTP request message is received from the browser region 242, the kernel region 244, at operation 510, may set a timer in order to attempt retransmission of the HTTP request message in the case where there is no response to the HTTP request message from the external server for a preset time. Further, the kernel region 244 may attempt to transmit the HTTP request message that is received from the browser region 242.

At operation 515, the filtering region 245 may hook the HTTP request message that is transferred to the kernel region 244 in the middle (i.e., before being transmitted). At operation 520, the filtering region 245 may extract address information and a reference field from the hooked HTTP request message. Further, the filtering region 245 confirms whether a pass or a block is set in the hooked HTTP request message. When the pass or the block is not set, the filtering region 245, at operation 525, may transfer the extracted address information and reference field to the verification region 243.

At operation 530, the verification region 243 may determine the block or the pass with respect to the corresponding HTTP request message based on at least the address information of the transferred address information and reference field. Further, at operation 535, the verification region 243 may report the resultant information (i.e., a value that indicates the block or a value that indicates the pass) to the filtering region 245.

At operation 540, the filtering region 245 may set whether to transmit the HTTP request message (i.e., transmission block or pass) based on the reported resultant information. The set value may be kept for a specific time, and thereafter, it may be reset to a “value that indicates non-setting”. Here, the specific time may be, for example, “0.6 ms measured from the time when the HTTP request message is generated”, or “0.6 ms measured from the time when whether to set the block is set”. When the set value is reset, the verification process may be performed with respect to the HTTP request message that is hooked after the resetting even though the HTTP request message has been derived from the initial HTTP request message. That is, the above-described operations 525 to 540 may be performed again.

On the other hand, at operation 550, when there is no response from the external server for the preset time, the kernel region 244 may reconstruct the HTTP request message that is received from the browser region 242 and may attempt the retransmission.

At operation 555, the filtering region 245 may hook the HTTP request message that is reconstructed by the kernel region 244 in the middle (i.e., before being transmitted). At operation 560, the filtering region 245 may extract address information and a reference field from the hooked HTTP request message. Further, the filtering region 245 confirms whether the pass or block is set in the hooked HTTP request message. If the block is set, the filtering region 245 interrupts transmission at operation 565. When the block is set, the filtering region 245, at operation 570, may transmit 200 OK of HTTP for notifying that the connection-requested site is blocked to the browser region 242 through the kernel region 244. Accordingly, at operation 575, the browser region 242 may display a message for notifying that the requested site is a blocked site.

When the pass is set, the filtering region 245, at operation 580, may transmit the HTTP request message to the external server. Accordingly, at operation 585, the kernel region 244 may receive a response message from the external server, and may transfer the received message to the browser region 242. Then, at operation 590, the browser region 242 may display the corresponding web page.

The method according to the present disclosure as described above may be implemented by program commands that can be performed through various computers and may be recorded in a non-transitory computer-readable recording medium. Here, the recording medium may include program commands, data files, and data structures. Further, the program commands may be specially designed and configured for the present disclosure or may be known to computer software providers to be available. Further, the recording medium may include a magnetic medium, such as a hard disk, a floppy disk, or a magnetic tape, an optical medium, such as Compact Disc-ROM (CD-ROM) or Digital Versatile Disc (DVD), a magneto-optical medium, such as a floptical disk, or hardware, such as a ROM, a RAM, or a flash memory. Further, the program command may include not only a machine code made by a compiler but also a high-level language code that can be executed by a computer using an interpreter.

The method and device according to the present disclosure are not limited to the embodiments as described above, and various changes in form and detail may be made within the range that is permitted by the technical concept of the present disclosure.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for processing a Hyper Text Transfer Protocol (HTTP) message in an electronic device, the method comprising:
recognizing a user's HTTP request input;
generating a first HTTP request message in response to the HTTP request input;
verifying the first HTTP request message;
transmitting the first HTTP request message when a pass of the first HTTP request message is determined as the result of the verification; and
transmitting a second HTTP request message derived from the first HTTP request message without verifying the second HTTP request message.

2. The method of claim 1, wherein the verifying of the first HTTP request message comprises:
hooking, by a filtering region of the electronic device, the first HTTP request message before a kernel region of the electronic device transmits the first HTTP request message;
extracting, by the filtering region, address information from the hooked first HTTP request message and transferring the address information to a verification region;
verifying, by the verification region, the first HTTP request message based on the address information and transferring the result of the verification to the filtering region; and
setting, by the filtering region, whether to pass the first HTTP request message based on the result of the verification.

3. The method of claim 2, wherein the verification region returns a message indicating the block verification result when a blacklist of blocked sites comprises the address information.

4. The method of claim 2, wherein the verification region returns a message indicating the pass verification result when a whitelist of allowed sites comprises the address information.

5. The method of claim 2, wherein the second HTTP request message comprises the address information in a reference field.

6. The method of claim 1, wherein the transmitting of the derived HTTP request message comprises:
confirming, by the filtering region, a reference field of the second HTTP request message; and
transmitting, by the filtering region, the second HTTP request message when it is set to pass the first HTTP request message and when the second HTTP request message is derived from the first HTTP request message as the result of the confirming of the reference field.

7. The method of claim 1, wherein the transmitting of the derived HTTP request message comprises:
hooking, by the filtering region, the first HTTP request message again when the kernel region attempts to retransmit the first HTTP request message in a state where there is no response to the first HTTP request message for a preset time; and
transmitting, by the filtering region, the first HTTP request message when it is set to pass the first HTTP request message.

8. The method of claim 1, further comprising displaying a message that indicates the block when it is determined to block the first HTTP request message as the result of the verification.

9. The method of claim 1, wherein the transmitting of the second HTTP request message is performed for a preset time.

10. A non-transitory computer-readable storage medium encoded with instructions to perform the method of claim 1.

11. An electronic device comprising:
an input interface unit configured to generate a user's Hyper Text Transfer Protocol (HTTP) request input;
a memory configured to store a programming module configured to perform recognizing the HTTP request input, to generate a first HTTP request message in response to the HTTP request input, to verify the first HTTP request message, to transmit the first HTTP request message when a pass of the first HTTP request message is determined as the result of the verification, and to transmit a second HTTP request message derived from the first HTTP request message without verifying the second HTTP request message;
at least one processor configured to execute the programming module; and
a communication unit configured to perform data communication with an external server under the control of the at least one processor.

12. The electronic device of claim 11, wherein the at least one processor comprises:
a browser region configured to perform the recognizing and the generating;
a verification region configured to execute the verifying; and
a kernel region configured to execute transmitting the first HTTP request message and transmitting the second HTTP request message.

13. The electronic device of claim 12, wherein the verification region returns a message indicating the block verification result when a blacklist of blocked sites comprises the address information.

14. The electronic device of claim 12, wherein the verification region returns a message indicating the pass verification result when a whitelist of allowed sites comprises the address information.

15. The electronic device of claim 12, wherein the second HTTP request message comprises address information extracted from the first HTTP request message in a reference field.

16. The electronic device of claim 12, wherein the at least one processor further comprises a filtering region,
wherein the filtering region hooks the first HTTP request message before the first HTTP request message is transmitted, extracts address information from the hooked first HTTP request message, transfers the address information to the verification region, receives the result of the verification based on the address information from the verification region, and sets whether to pass the first HTTP request message based on the result of the verification.

17. The electronic device of claim 16, wherein the filtering region transmits a second HTTP request message when it is set to pass the first HTTP request message or when the second HTTP request message is derived from the first HTTP request message as a result of confirming a reference field of the second HTTP request message.

18. The electronic device of claim 16, wherein the filtering region hooks the first HTTP request message again when retransmission of the first HTTP request message is attempted in a state where there is no response to the first HTTP request message for a preset time, and transmits the first HTTP request message when it is set to pass the first HTTP request message.

19. The electronic device of claim 16, wherein the filtering region exists in the kernel region.

20. The electronic device of claim 11, wherein the programming module is configured to display a message that indicates the block when it is determined to block the first HTTP request message as the result of the verification.

21. The electronic device of claim 11, wherein transmitting the second HTTP request message is performed for a preset time.
